(19) United States
(12) Patent Application Publication
(10) Pub. No.: US 2010/0218140 A1
(43) Pub. Date: Aug. 26, 2010

(54) GRAPHICAL USER INTERFACE FOR MULTI-MODAL IMAGES AT INCREMENTAL ANGULAR DISPLACEMENTS

(76) Inventors: Gilbert D. Feke, Durham, CT (US); Douglas O. Wood, North Haven, CT (US); William E. McLaughlin, Guilford, CT (US); Douglas L. Vizard, Durham, CT (US); Warren M. Leevy, Granger, IN (US); Sean Orton, Shelton, CT (US); Willis Morse, Milford, CT (US)

Correspondence Address: Carestream Health, Inc.;ATTN: Patent Legal Staff, 150 Verona Street, Rochester, NY, 14608, US

(21) Appl. No.: 12/716,331

(22) Filed: Mar. 3, 2010

Related U.S. Application Data
(63) Continuation-in-part of application No. 11/221,530, filed on Sep. 8, 2005, now Pat. No. 7,734,325.
Application No. 11/221,530 is a continuation-in-part of application No. 12/381,599, filed on Mar. 13, 2009.
Application No. 12/381,599 is a continuation-in-part of application No. 12/475,623, filed on Jun. 1, 2009.
(60) Provisional application No. 61/209,182, filed on Mar. 4, 2009.

(51) Int. Cl. G09G 5/377; G09G 5/02; G06F 3/048

(52) U.S. Cl. 715/810; 345/634; 345/592; 715/764

(57) ABSTRACT

A method for forming a sequence of images of a subject obtains at least first and second image sets of the subject, each image set having a given angular displacement relative to an axis of rotation of the subject, each image set having at least a first component image of a first diagnostic modality at the given angular displacement and a second component image that is co-registered to the first component image at the given angular displacement. The first image set is selected as the selected image set for display. A synthesized image is formed by combining image data for the at least first and second component images of the selected image set and the synthesized image is displayed.

### CROSS REFERENCE TO RELATED APPLICATIONS

The present application claims priority to provisional U.S. Patent Application Ser. No. 61/209,182, filed Mar. 4, 2009 by Feke et al., entitled “GRAPHICAL USER INTERFACE FOR VISUALIZING AND ANALYZING A SERIES OF SETS OF MULTI-MODAL IMAGES OF AN OBJECT UNDERGOING INCREMENTAL ANGULAR DISPLACEMENT”.

This application is a Continuation-In-Part of the following commonly assigned co-pending applications:

U.S. patent application Ser. No. 11/221,530 by Vizard et al., published as U.S. 2006/0064000, filed Sep. 9, 2005 entitled APPARATUS AND METHOD FOR MULTI-MODAL IMAGING;

U.S. patent application Ser. No. 12/381,599 by Feke et al., published as U.S. 2009/0238434, filed Mar. 31, 2009 entitled METHOD FOR REPRODUCING THE SPATIAL ORIENTATION OF AN IMMOBILIZED SUBJECT IN A MULTIMODAL IMAGING SYSTEM; and

U.S. patent application Ser. No. 12/475,623 by Feke et al., published as U.S. 2010/0022866 filed Jun. 13, 2008 entitled TORSIONAL SUPPORT APPARATUS AND METHOD FOR CRANIOCAUDAL ROTATION OF ANIMALS.

### FIELD OF THE INVENTION

The invention relates generally to the field of imaging systems, and more particularly to multi-modal imaging of objects. More specifically, the invention relates to a graphical user interface for visualizing and analyzing a series of sets of multi-modal images, and synthesized images thereof; of an object undergoing incremental angular displacement.

### BACKGROUND OF THE INVENTION

Electronic imaging systems are known for imaging of animals, for example, mice and other small lab animals. An exemplary electronic imaging system (shown in FIGS. 1A, 1B, 1C, and 1D) is the KODAK In-Vivo Imaging System FX Pro 100.

FIG. 1A shows a perspective view of an electronic imaging system 100. FIG. 1B shows a diagrammatic side view of electronic imaging system 100. FIG. 1C shows a diagrammatic front view of electronic imaging system 100. FIG. 1D shows a detail perspective view of electronic imaging system 100.

System 100 includes a light source 12; a sample environment 108 which allows access to the object being imaged; an optically transparent platen 104 disposed within sample environment 108; an epi-illumination delivery system comprised of fiber optics 106 which are coupled to light source 12 and direct conditioned light (of appropriate wavelength and divergence) toward platen 104 to provide bright-field or fluorescence imaging; an optical compartment 14 which includes a mirror 16 and a lens/camera system 18; a communication/computer control system 20 which can include a display device, for example, a computer monitor; a microfocus X-ray source 102; an optically transparent planar animal support member 160 onto which subjects may be immobilized and stabilized by gavity; and a high-resolution phosphor screen 200, adapted to transduce ionizing radiation to visible light by means of high-resolution phosphor sheet 205, which is proximate to animal support member 160 and removable along direction indicated by arrow 201.

Light source 12 can include an excitation filter selector for fluorescence excitation or bright-field color imaging.

Sample environment 108 is preferably light-tight and fitted with light-locked gas ports for environmental control. Such environmental control might be desirable for controlled X-ray imaging or for life-support of particular biological specimens.

Imaging system 100 can include an access means/member 110 to provide convenient, safe and light-tight access to sample environment 108. Access means are well known to those skilled in the art and can include a door, opening, labyrinth, and the like.

Additionally, sample environment 108 is preferably adapted to provide atmospheric control for sample maintenance or soft X-ray transmission (e.g., temperature/humidity/alternative gases and the like).

Lens/camera system 18 can include an emission filter wheel for fluorescent imaging.

The following references provide examples of electronic imaging systems suited for multi-modal imaging, all of which are incorporated herein by reference.

U.S. patent application Ser. No. 12/196,300 filed Aug. 22, 2008 by Harder et al., entitled APPARATUS AND METHOD FOR MULTI-MODAL IMAGING USING NANOPARTICLE MULTI-MODAL IMAGING PROBES, published as U.S. 2009/0086908.

U.S. patent application Ser. No. 11/221,530 by Vizard et al., Publication US 2006/0064000 filed Sep. 9, 2005 entitled APPARATUS AND METHOD FOR MULTI-MODAL IMAGING.

U.S. patent application Ser. No. 12/354,830 filed Jan. 16, 2009 by Feke et al., entitled APPARATUS AND METHOD FOR MULTI-MODAL IMAGING, published as U.S. 2009/0159805.

U.S. Patent Application Publication No. 2009/0238434 by Feke et al., filed Mar. 31, 2009 entitled METHOD FOR REPRODUCING THE SPATIAL ORIENTATION OF AN IMMOBILIZED SUBJECT IN A MULTIMODAL IMAGING SYSTEM.

U.S. Patent Application Publication No. 2010/0022866 filed Jun. 13, 2008 by Feke et al., entitled TORSIONAL SUPPORT APPARATUS AND METHOD FOR CRANIOCAUDAL ROTATION OF ANIMALS.

With the imaging system shown in FIGS. 1A-1D and described in these disclosures, precisely co-registered probes (e.g., fluorescent, luminescent and/or isotopic) within an object (e.g., a live animal and tissue) can be localized and multiple images can be readily overlaid onto the simple bright-field reflected image or anatomical x-ray of the same animal shortly after animal immobilization.

In operation, system 100 is configured for a desired imaging mode chosen among the available modes including bright-field mode, fluorescence mode, luminescence mode, X-ray mode, and radioactive isotope mode. An image of an immobilized subject, such as mouse/animal 150 under anesthesia and recumbent upon optically transparent animal support member 160, is captured using lens/camera system 18. System 18 converts the light image into an electronic image, which can be digitized. The digitized image can be displayed on the display device, stored in memory, transmitted to a remote location, processed to enhance the image, and/or used to print a permanent copy of the image. The system may be successively configured for capture of multiple images, each image chosen among the available modes, whereby a synthesized image, such as a composite overlay, is synthesized by the layered combination of the multiple captured component images. Furthermore, a regions-of-interest analysis may be performed on the images, as is known in the art.

Animal 150 may successively undergo cranio-caudal rotation and immobilization directly onto planar animal support member 160 in various recumbent body postures, such as prone, supine, laterally recumbent, and obliquely recumbent, whereby the mouse is stabilized by gravity for each body posture, to obtain multiple views, for example ventral and lateral views, and whereby a set of multi-modal images is captured for each rotation angle as described in “Picture Perfect: Imaging Gives Biomarkers New Look”, P. Mitchell, Pharma DD, Vol. 1, No. 3, pp. 1-5 (2006). Alternatively, mouse 150 may be immobilized in a right circular cylindrical tube, as is known in the art, and undergo incremental angular displacement whereby a set of multi-modal images is captured for each rotation angle. Alternatively, animal 150 may be immobilized in an apparatus as described in the Feke et al. '2866 application noted earlier, and undergo incremental angular displacement whereby a set of multi-modal images is captured for each rotation angle. Angular displacement is shown generally by arrow 151 in FIG. 1D.

As described in U.S. patent application Ser. No. 11/221,530 by Vizard et al., Publication US 2006/0064000 filed Sep. 9, 2005 and entitled APPARATUS AND METHOD FOR MULTI-MODAL IMAGING, there can be more than one imaging mode when using electronic imaging system 100. To provide this feature, electronic imaging system 100 includes first means for imaging the immobilized object in a first imaging mode to capture a first image, and at least a second means for imaging the immobilized object in a second imaging mode, different from the first imaging mode, to capture a second image. The first imaging mode is selected from the group: x-ray mode and radio isotopic mode. The second imaging mode is selected from the group: bright-field mode and dark-field mode. Images in additional modes can also be obtained. A removable phosphor screen is employed when the first image is captured and not employed when the second image is captured. The phosphor screen is adapted to transduce ionizing radiation to visible light. The phosphor screen is adapted to be removable without moving the immobilized object The system can further include means for synthesizing a third overlay-synthesized image comprised of first and second image layers.

Electronic imaging system 100 may further include software capable of spectrally unmixing a plurality of fluorescent molecular signals from a series of images of the fluorescence mode, wherein the series comprises a plurality of excitation wavelengths, a plurality of emission wavelengths, or both, and synthesizing a plurality of additional unmixed-synthesized images corresponding to the plurality of fluorescent molecular signals, as is known in the art. Furthermore, one or more of the unmixed-synthesized images of the fluorescent molecular signals may be combined with an image of a different mode, such as an X-ray image, to further synthesize an additional overlay-synthesized image comprised thereof, as is known in the art.

Multi-modal imaging allows research personnel to take advantage of the various different types of images that can be obtained with electronic imaging system 100 and related equipment. Multi-modal images, formed by combining image data from images of different modes, suitably scaled and registered to each other, can be very useful for monitoring drug or disease conditions in the laboratory environment, for example.

As noted earlier, the Vizard et al. '4000 application describes methods and apparatus for generating multi-modal images. The Feke et al. '8434 application, also previously noted, describes procedures for registration and spatial orientation for multi-modal images. Using the methods and techniques described in these applications enables suitable image content for multi-modal images to be collected for recombination and display. Advantageously, this includes capture of multi-modal images of a subject at multiple angular rotations. For example, a mouse can be imaged in two or more modes, with multiple images obtained at the same cranio-caudal rotation angles.

Although multi-modal imaging is recognized as having considerable promise, conventional image display tools are cumbersome and can require significant manual interaction and command entry and manipulation. Conventional tools fail to take advantage of features of multi-modal imaging apparatus, such as the capability to obtain a succession of images, in two or more modalities, at each of a number of rotational angles.

There would be advantages to a graphical user interface that provided display features such as the following: (i) display of synthesized images formed by layered combinations of multi-modal images at an operator-designated view angle or angles; (ii) operator selection of component images of suitable modalities for forming the synthesized images that are displayed; (iii) capability for automatic display of synthesized images, sequencing through a succession of view angles; (iv) controls for adjusting image characteristics and parameters for each of the component images of suitable modalities for forming the synthesized images that are displayed, including characteristics such as color and contrast, for example; and (v) image pan and zoom functions that work in concert with image display (iii) and controls for image characteristics and parameters (iv).

Thus, there is a need for a graphical user interface that takes advantage of the unique capabilities and features of multi-modal imaging systems that obtain images of an object undergoing incremental angular displacement.

### PROBLEM TO BE SOLVED

Applicants have recognized a need for a graphical user interface, using a computer, to enable visualization and analysis of a series of sets of multi-modal images, and synthesized images thereof, of an object undergoing incremental angular displacement. For example, for an immobilized subject, such as a mouse under anesthesia. Applicants have recognized a need for a graphical user interface that provides one or more displays, as well as controls and indicators, for image browsing and animated review of the images as a function of both modality and rotation angle.

### SUMMARY OF THE INVENTION

It is an object of the present invention to address the need for a gaphical user interface that facilitates viewing of a series of sets of multi-modal images, and synthesized images thereof, of an object at any number of incremental angular displacement positions relative to an axis of rotation. With this object in mind, apparatus and methods of the present invention provide a graphical user interface, using a computer, wherein the graphical user interface comprises one or more display windows capable of showing still-image or animated-image content such as: (a) a user-selected component image from a user-selected set of multi-modal images from a series of sets of multi-modal images of an object undergoing incremental angular displacement; (b) a movie animation of a series of component images of an object undergoing incremental angular displacement, wherein the series of images is of a user-selected mode from a set of modes; (c) a user-selected overlay-synthesized image from a series of overlay-synthesized images of an object undergoing incremental angular displacement, wherein the user-selected overlay-synthesized image is synthesized by the composite overlay of at least two user-selected component multi-modal image layers from a user-selected set of multi-modal images; (d) a movie animation of a series of overlay-synthesized images of an object undergoing incremental angular displacement, wherein each overlay-synthesized image in the series of images is synthesized by the composite overlay of at least two component multi-modal image layers, wherein the at least two multi-modal image layers are of user-selected modes from a set of modes; (e) a user-selected unmixed-synthesized image from a user-selected set of unmixed-synthesized images from a series of sets of unmixed-synthesized images of an object undergoing incremental angular displacement; (f) a movie animation of a series of unmixed-synthesized images of an object undergoing incremental angular displacement; (g) a user-selected overlay-synthesized image from a series of overlay-synthesized images of an object undergoing incremental angular displacement, wherein the overlay-synthesized image is synthesized by the composite overlay of at least one unmixed-synthesized image layer and an image layer from a user-selected second mode from a set of modes; or (h) a movie animation of a series of overlay-synthesized images of an object undergoing incremental angular displacement, wherein each overlay-synthesized image in the series of images is synthesized by the composite overlay of at least one unmixed-synthesized image layer and an image layer from a user-selected second mode from a set of modes.

In each case (a), (b), (c), (d), (e), (f), (g), and (h) the images may be processed according to a user configuration to enhance the image.

According to one aspect of the invention, there is provided a method for forming a sequence of images of a subject, the method comprising: obtaining at least first and second image sets of the subject, wherein each image set has a given angular displacement relative to an axis of rotation of the subject, each image set comprising at least: (i) a first component image of a first diagnostic modality at the given angular displacement; (ii) a second component image that is co-registered to the first component image at the given angular displacement, selecting the first image set as the selected image set for display; forming a synthesized image by combining image data from the at least first and second component images of the selected image set; and displaying the synthesized image.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings arc not necessarily to scale relative to each other.

FIG. 1A shows a perspective view of an exemplary prior art electronic imaging system including a removable high-resolution phosphor screen.

FIG. 1B shows a diagrammatic side view of the prior art electronic imaging system of FIG. 1A.

FIG. 1C shows a diagrammatic front view of the prior art electronic imaging system of FIG. 1A.

FIG. 1D shows a detailed perspective view of the prior art electronic imaging system of FIG. 1A.

FIG. 2A shows an overall workflow diagram for cranio-caudal rotation of an animal in accordance with a method of the present invention.

FIG. 2B shows a workflow diagram in accordance with a method of the present invention.

FIG. 2C shows a workflow diagram in accordance with a method of the present invention.

FIG. 3 is a schematic diagram that shows parts of an imaging system that are used to provide component images that are combined in some way to form multi-modal images

FIG. 4 is a schematic diagram showing a group with a plurality of image sets for forming synthesized images.

FIG. 5 is a logic flow diagram that shows steps of a method for forming a sequence of synthesized multi-modal images of a subject.

FIG. 6A shows a first component image of an immobilized object in a first imaging mode.

FIG. 6B shows a second component image of the immobilized object of FIG. 6A in a second imaging mode.

FIG. 6C shows a synthesized image generated by the merger of the component images of FIGS. 6A and 6B.

FIG. 7 shows a graphical user interface in accordance with one embodiment of the present invention with a display window that displays a synthesized image.

FIG. 8 shows a scale for angular increment selection and a component image selection panel.

FIG. 9 shows a histogram and contrast setting for a single component image.

FIG. 10 shows a pseudo-color control that applies for the corresponding component image.

FIG. 11 shows an image transparency control that applies for the corresponding component image.

FIG. 12 shows an image smoothing control that applies for the corresponding component image.

FIG. 13 shows a zoom control for the synthesized image.

FIG. 14 shows how an image panning function is implemented in one embodiment.

FIG. 15 shows a graphical user interface with dual-display of multi-modal synthesized images at incremental angular displacements.

### DETAILED DESCRIPTION OF THE INVENTION

The invention is described in detail with particular reference to certain preferred embodiments thereof, but it will be understood that variations and modifications can be effected within the spirit and scope of the invention. The following is a detailed description of the preferred embodiments of the invention, reference being made to the drawings in which the same reference numerals identify the same elements of structure in each of the several figures.

As used herein, the terms “zeroeth”, “first”, “second”, and so on, do not necessarily denote any ordinal or priority relation, but may be simply used to more clearly distinguish one element from another.

The term “modality” or, alternately, “diagnostic modality” relates to the type of imaging that is used in order to obtain a diagnostic image. For example, x-ray imaging is one imaging modality; fluorescence imaging is another modality. A synthesized image is a “composite” image that is formed from two or more “component” images in combination. In the context of the present disclosure, a component image is obtained in a single image modality. A component image, or synthesized image may include image data from component images of one, two, or more diagnostic modalities.

The term “set”, as used herein, refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S.

Operator command entries on a graphical user interface can be made in a number of ways, using techniques well known in the user interface design arts. A cursor positioned on the display screen can be manipulated by a computer mouse or joystick, for example. Alternately, a touchscreen interface could be used for accepting operator commands.

In the context of the present disclosure, the terms “object” and “subject” are used interchangeably to refer to the physical entity that is imaged.

Applicants have recognized a need for a graphical user interface for visualizing and analyzing a series of sets of multi-modal images, and synthesized images thereof, of an object undergoing incremental angular displacement. As was noted previously in the background section, conventional solutions for display of multi-modal images, and synthesized images thereof, are relatively inflexible and difficult to use, requiring significant work on the part of the viewer in order to display multi-modal images, and synthesized images thereof, with different spatial orientations.

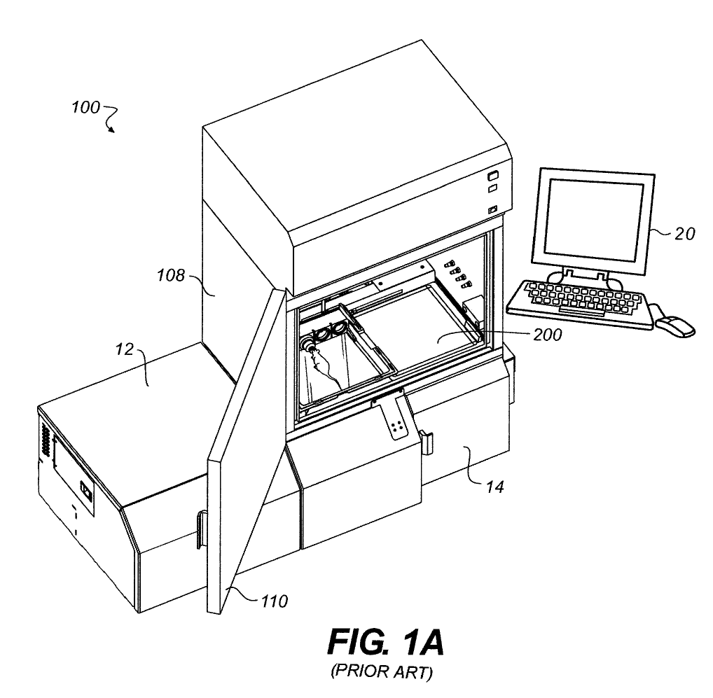

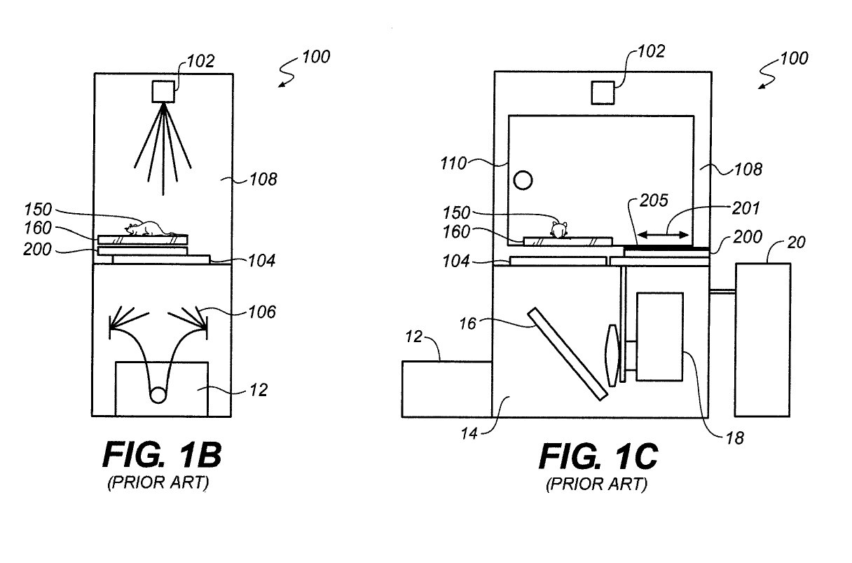

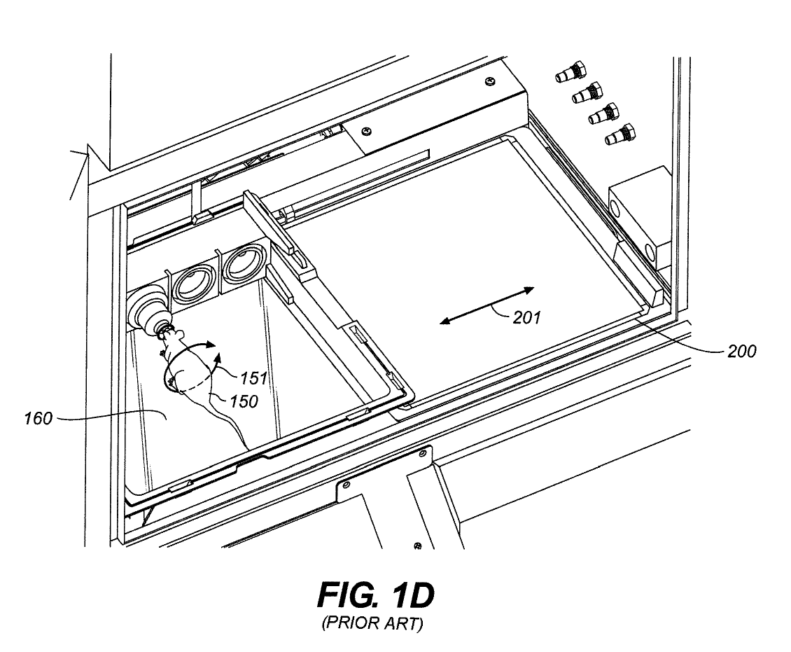

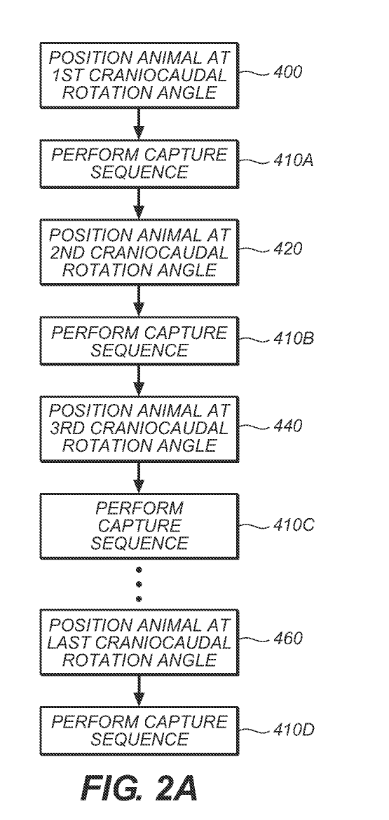

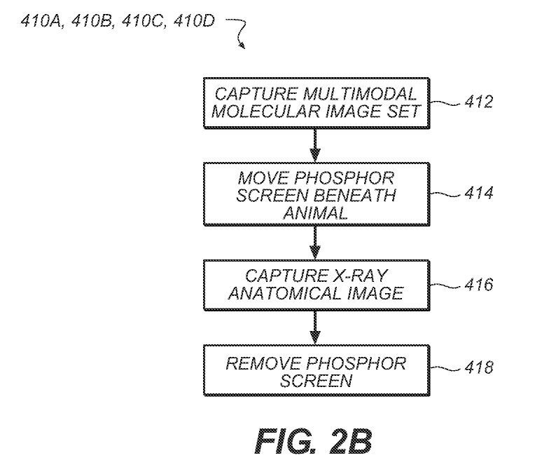

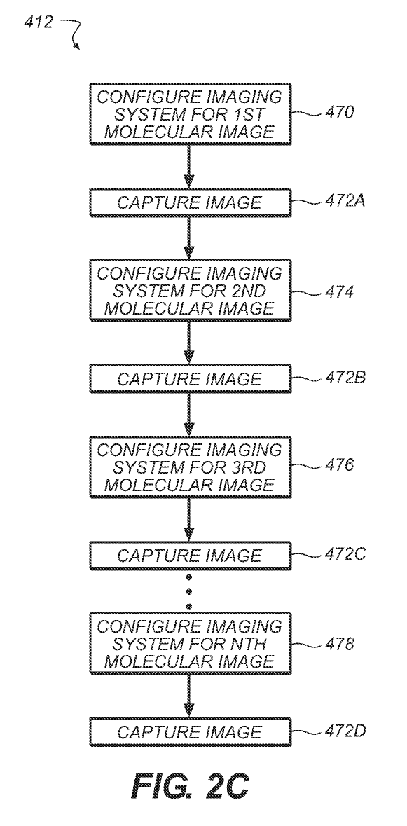

Referring again to imaging system 100 shown in FIGS. 1A-1D, FIGS. 2A-2C show workflow diagrams for obtaining multi-modal images of an animal, such as a mouse, in accordance with a method of the present invention. FIG. 2A shows the overall workflow diagram for cranio-caudal rotation of an animal. First, the animal is placed in a rotatable support apparatus at a first desired cranio-caudal rotation angle in step 400. Next, electronic imaging system 100 performs a capture sequence in step 410A. Next, the animal is positioned by the rotatable support apparatus at a second desired cranio-caudal rotation angle in step 420. Next, electronic imaging system 100 performs another capture sequence in step 410B. Next, the animal is positioned by the rotatable support apparatus at a third desired cranio-caudal rotation angle in step 440. Next, electronic imaging system 100 performs another capture sequence in step 410C. The animal is positioned by the rotatable support apparatus at as many different cranio-caudal rotation angles as desired, and electronic imaging system 100 performs capture sequences for each cranio-caudal rotation angle, until the animal is positioned by the rotatable support apparatus at the last cranio-caudal rotation angle in step 460; and electronic imaging system 100 performs the last capture sequence in step 410D. The distribution of the different cranio-caudal rotation angles within the range of rotation may be either periodic or arbitrary. The rotation direction between successive angles may be either constant, whether clockwise or counterclockwise, or may be arbitrary.

FIG. 2B shows a preferred embodiment of the workflow diagram for steps 410A, 410B, 410C, 410D. First, electronic imaging system 100 acquires a multi-modal molecular image set in step 412. Molecular imaging modes may include optical imaging modes such as fluorescence and luminescence modes, and also radioactive isotope imaging mode whereby application of a second phosphor screen or panel optimized for high sensitivity is preferable. Second, high-resolution phosphor screen 200 is moved into position under the animal in step 414. Third, electronic imaging system 100 acquires an X-ray anatomical image in step 416. Last, high-resolution phosphor screen 200 is removed from beneath the animal in step 418. Alternatively, steps 410A, 410B, 410C, and 410D may exclude steps 414, 416, and 418, and include only step 412. Alternatively, high-resolution phosphor screen 200 may be fixed in place beneath the animal and steps 410A, 410B, 410C, and 410D may exclude steps 412, 414, and 418, and include only step 416.

FIG. 2C shows the workflow diagram for step 412. First, electronic imaging system 100 is configured for a first molecular image in step 470. Next, electronic imaging system 100 captures an image in step 472A. Next, electronic imaging system 100 is configured for a second molecular image in step 474. Next, electronic imaging system 100 captures another image in step 472B. Next, electronic imaging system 10 is configured for a third molecular image in step 476. Next, electronic imaging system 100 captures another image in step 472C. Electronic imaging system 100 is configured for and captures as many different molecular images as desired, until electronic imaging system 100 is configured for the last molecular image in step 478 and captures the last image in step 472D. The different configurations of electronic imaging system 100 may involve selection of different excitation and emission wavelengths, toggling illumination on or off, and installation or removal of a second high-sensitivity phosphor screen or panel for radioactive isotope imaging. The images that are captured in this image sequence are stored in memory circuitry that is accessible to communication/computer control system 20 (FIG. 1C) for subsequent display in combined form.

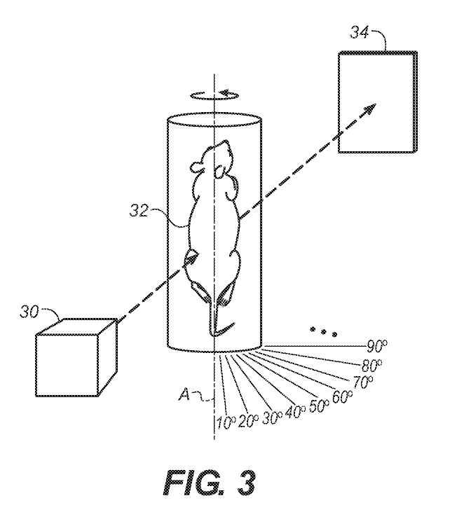

More generally, the simplified schematic diagram of FIG. 3 shows parts of an imaging system that are used to obtain component images whose content is combined in some way to form synthesized images. A radiation source 30 directs incident radiation of a suitable type toward object 32, such as a mouse as shown in FIG. 3. Depending on the type of image obtained, the radiation can be x-rays, visible light, or light outside the visible spectrum. Alternatively, the object 32 can itself be a source of radiation. A sensor 34 then generates the image data based on the resulting radiation that it receives. For x-ray imaging, for example, radiation source 30 directs x-ray radiation and a phosphor plate or digital radiography (DR) detector can be used as sensor 34. For fluorescent imaging, a light source provides an excitation radiation and a CCD or CMOS sensor array is used as sensor 34. Depending on the type of sensor, the same sensor may be used for more than one, or even for all imaging modalities. Object 32 is imaged at any of a number of suitable angular displacements, with rotation relative to a rotation axis A. For mouse imaging, a cranio-caudal axis, as previously described, is conventionally used as the reference rotation axis A and the specimen is rotated about that axis with the radiation source 30 and sensor 34 in the same positions. Alternately, radiation source 30 and sensor 34 could be moved about the subject, such as on a rotatable gantry, for example. It can be appreciated that the simplified model of FIG. 3 applies for imaging system 100 described with reference to FIGS. 1A-1D or to any other imaging apparatus, or combination with more than one apparatus that obtains, at particular rotational angles, component images of modalities that, when co-registered, can be combined to form synthesized images.

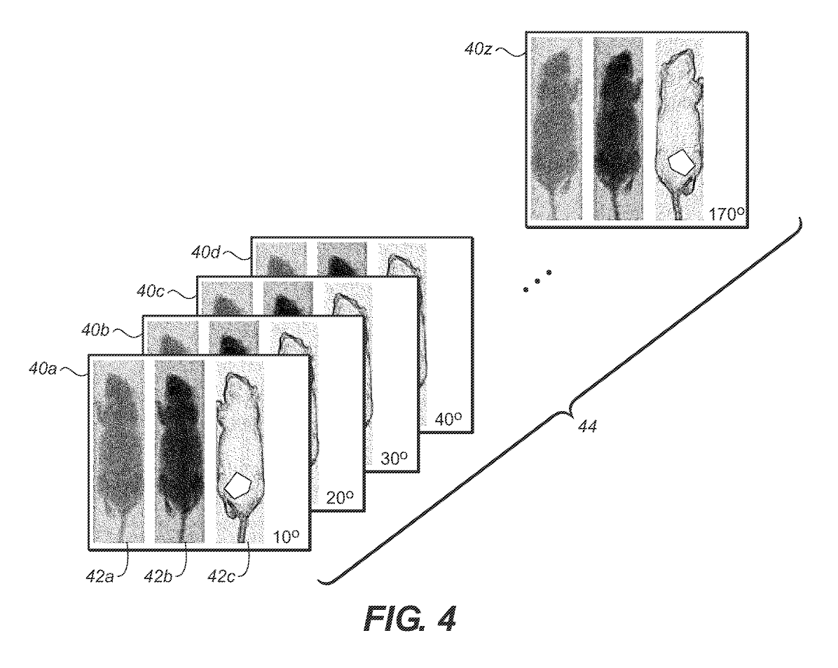

Synthesized images are formed from sets of co-registered component images that are logically associated with each other for the same subject. The schematic diagram of FIG. 4 shows a number of image sets 40a, 40b, 40c, 40d, . . . 40z, that are in a group 44. Each set contains two or more co-registered component images of different modes. In the example of FIG. 4, set 40 includes an x-ray component image 42a, a bright field mode component image 42b, and a fluorescence component image 42c. For this example, x-ray component image 42a is considered to be a zeroeth modality; bright field mode component image 42b is considered to be a first modality; fluorescence component image 42c is considered to be a second modality. Alternately, two or more of the co-registered component images in an image set can be of the same imaging modality but with different spectral content, such as multispectral or hyperspectral images for example, or can differ in some other manner due to image post-processing, for example.

Still referring to FIG. 4, each image set 40a, 40b, 40c, 40d, . . . 40z has a corresponding angular displacement relative to an axis of rotation, here a cranio-caudal rotation angle about an axis A. For example, set 40a has component images with a cranio-caudal rotation angle of 10 degrees; set 40b has component images with a cranio-caudal rotation angle of 20 degrees, and so on. Set 40z has a cranio-caudal rotation angle of 170 degrees. It must be emphasized that FIG. 4 is representative of one embodiment and is given by way of example only. Image sets can have two or more co-registered component images of the same or of different modalities, with each component image in a set obtained at the same rotation angle. The relative angular displacement between image sets can be at increments of any suitable number of degrees. The component images themselves can be obtained on the same imaging apparatus, such as electronic imaging system 100 that provides multi-modal imaging in an automated manner and advantageously provides uniformity in how rotation takes place and how registration between images is achieved. Alternately, the component images within any image set can be obtained from different imaging apparatus. Scaling and registration of component images from different imaging apparatus would be required in order for image content to be properly combined.

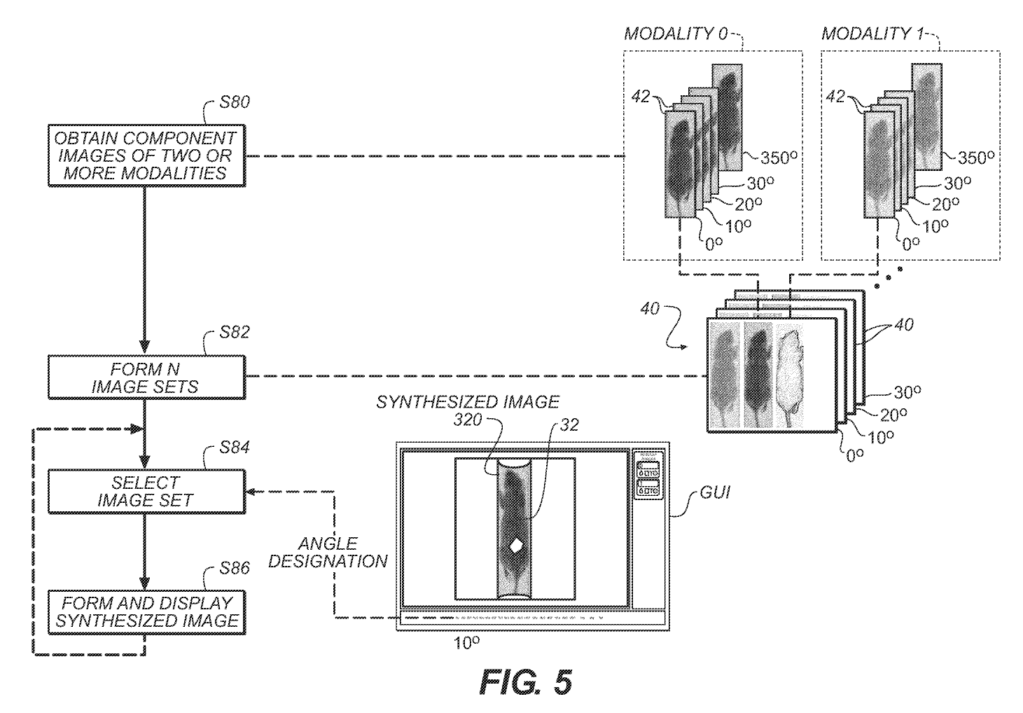

The logic flow diagram of FIG. 5 shows steps of a method, executed by imaging system 100 or using one or more alternate imaging apparatus, for forming image sets 40 and for forming a sequence of synthesized images of a subject from component images obtained from the image sets. In a component image obtaining step S80, component images 42 of the subject are obtained in one, two, or more modalities, at the same angular displacements. In an image set forming step S82, a group of image sets 44 consisting of a number N of image sets, wherein integer N≧2, is formed, each image set in group 44 having a corresponding angular displacement value relative to the axis of rotation, as was described with reference to FIG. 4. An image set selection step S84 designates a particular image set for a synthesized image forming and display step S86. The selection of the image set can be performed, for example, by an operator-entered angle designation, using user interface command entry tools described in more detail subsequently. Alternately, as shown in the dashed line loop in FIG. 5, steps S84 and S86 are repeated, displaying a composite synthesized image 320 from each image set in sequence. For the example data shown in FIG. 5, this means display of a first synthesized image at 0 degrees, followed by display of a second synthesized image at 10 degrees, followed by display of a third synthesized image at 20 degrees, and so on. Rapid cycling through synthesized images obtained from image sets in this way allows simulated motion of the subject 32 in rotation.

With respect to the logic flow shown in FIG. 5, it can be appreciated that image set forming step S82 allows a number of variations for forming a group 44 of image sets for display, and that execution of this step can form data sets of variable sizes and types. A group 44 can comprise multiple images of different types relative to an experiment, for example. As already noted, component images 42 of one, two, or more different modalities are obtained, with the component images typically obtained from the same electronic imaging system 100, as in FIGS. 1A-1D, but alternately obtained from two or more different imaging systems, as noted earlier. Where component images are of different dimensions, various methods would be applied for registering image content from the different component images, using techniques well known in the image manipulation arts. Each image set 40 has a corresponding angular displacement, with image sets in a group 44 of image sets typically differing by equal angular increments. Characteristics of the particular group 44 that is formed and are then used for display of the image sets, as described subsequently, include the following:
(i) Types of images obtained (for example, x-ray, fluorescence, bright field, luminescence, radioisotopic); and
(ii) Number of images (the same number of each type) and corresponding angular displacements.

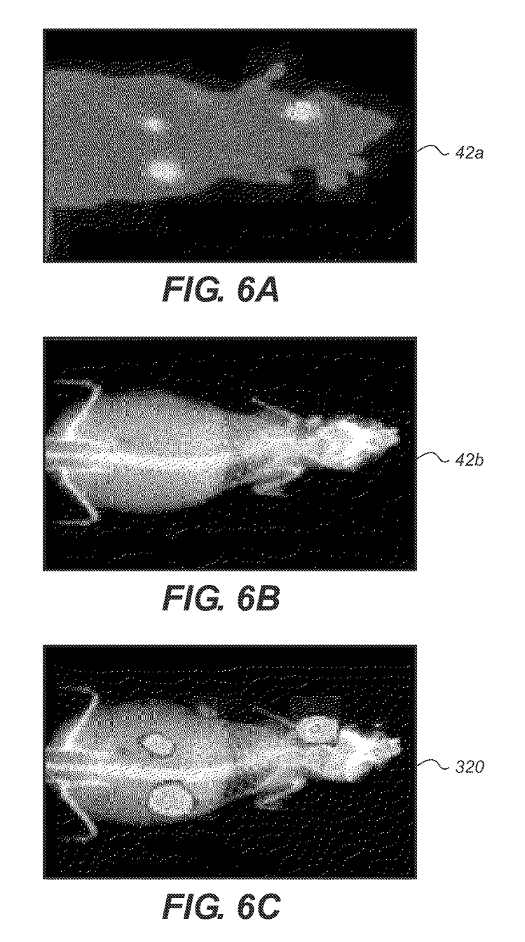

By way of an example, FIGS. 6A-6C, show images captured using electronic imaging system 100 of FIGS. 1A-1D. A mouse was immobilized on platen 104 of system 100. System 100 was first configured for near IR fluorescence imaging wherein phosphor screen 200 is removed. A first component image 42a of this modality was captured and is displayed in FIG. 6A. Next, system 100 was configured for x-ray imaging wherein phosphor screen 200 is placed in co-registration. A second component image was captured and is displayed in FIG. 6B. Using methods known to those skilled in the art, the first and second component images were merged and the merged image is displayed as synthesized image 320 in FIG. 6C. Note that the fluorescent signals superimposed on the anatomical reference clarify the assignment of signal to the bladder and an expected tumor in the neck area of this illustrated experimental mouse.

It is noted that the first and/or second component images 42a and 42b can be enhanced using known image processing methods/means prior to being merged together to form synthesized image 320. Alternatively, merged, synthesized image 320 can be enhanced using known image processing methods/means. Often, false color is used to distinguish fluorescent signal content from gray-scale x-rays in a merged, synthesized image, for example.

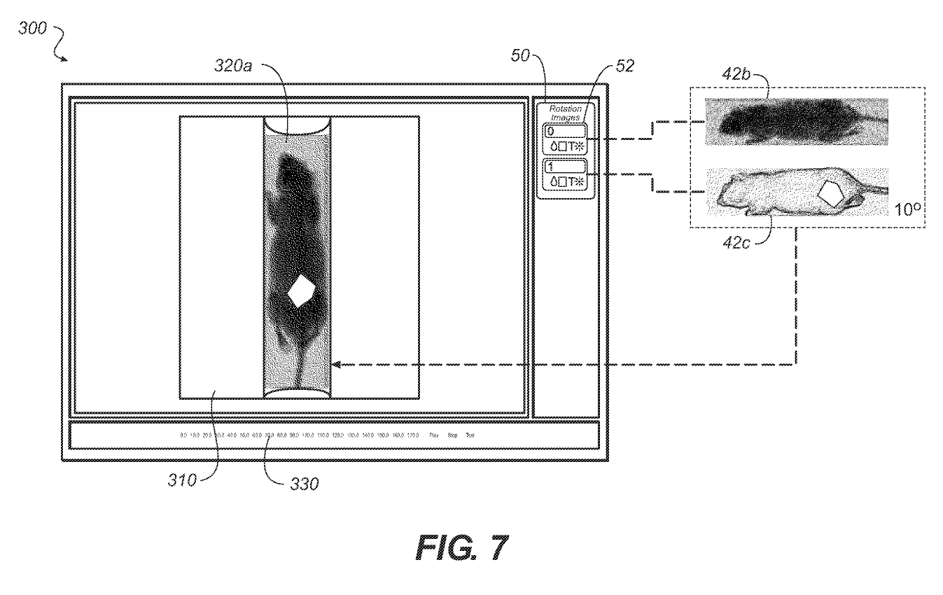

FIG. 7 shows a graphical user interface 300 in accordance with one embodiment of the present invention wherein the graphical user interface 300 comprises a display area, shown as a display window 310, wherein display window 310 displays a synthesized image 320a. In this example, synthesized image 320a is formed from image set 40a of FIG. 4, using two component images 42b and 42c. Alternately, synthesized image 320a can be formed using a combination of any two or more images from the same image set. Thus, for example, synthesized image 320a in FIG. 7 could alternately be formed from component images 42a and 42c, or from images 42a and 42b, or from all three images 42a, 42b, and 42c.

Image combination for forming a synthesized image can be done in a number of ways. Types of synthesized images that can be formed include the following:
(i) overlay-synthesized image, formed by overlaying or otherwise combining image content of two or more different image modalities; and
(ii) unmixed-synthesized image, formed as a combination from image content of two or more images of the same image modality, wherein the different component images that are combined are of different spectral bands or have undergone different post-processing operations to derive or to enhance image content of particular diagnostic interest.

Display window 310 displays at least one of the following types of content as a synthesized image:
(a) a user-selected component image from a user-selected set of multi-modal images from a series of sets of multi-modal images of an object undergoing incremental angular displacement;
(b) a movie animation of a series of component images of an object undergoing incremental angular displacement, wherein the series of images is of a user-selected mode from a set of modes;
(c) a user-selected overlay-synthesized image from a series of overlay-synthesized images of an object undergoing incremental angular displacement, wherein the user-selected overlay-synthesized image is synthesized by the composite overlay of at least two user-selected component multi-modal image layers from a user-selected set of multi-modal images;
(d) a movie animation of a series of overlay-synthesized images of an object undergoing incremental angular displacement, wherein each overlay-synthesized image in the series of images is synthesized by the composite overlay of at least two component multi-modal image layers, wherein the at least two multi-modal image layers are of user-selected modes from a set of modes;
(e) a user-selected unmixed-synthesized image from a user-selected set of unmixed-synthesized images from a series of sets of unmixed-synthesized images of an object undergoing incremental angular displacement;
(f) a movie animation of a series of unmixed-synthesized images of an object undergoing incremental angular displacement;
(g) a user-selected overlay-synthesized image from a series of overlay-synthesized images of an object undergoing incremental angular displacement, wherein the overlay-synthesized image is synthesized by the composite overlay of at least one unmixed-synthesized image layer and an image layer from a user-selected second mode from a set of modes; or
(h) a movie animation of a series of overlay-synthesized images of an object undergoing incremental angular displacement, wherein each overlay-synthesized image in the series of images is synthesized by the composite overlay of at least one unmixed-synthesized image layer and an image layer from a user-selected second mode from a set of modes.

In each case (a), (b), (c), (d), (e), (f), (g), and (h) the images may be processed according to a user configuration to enhance the image.

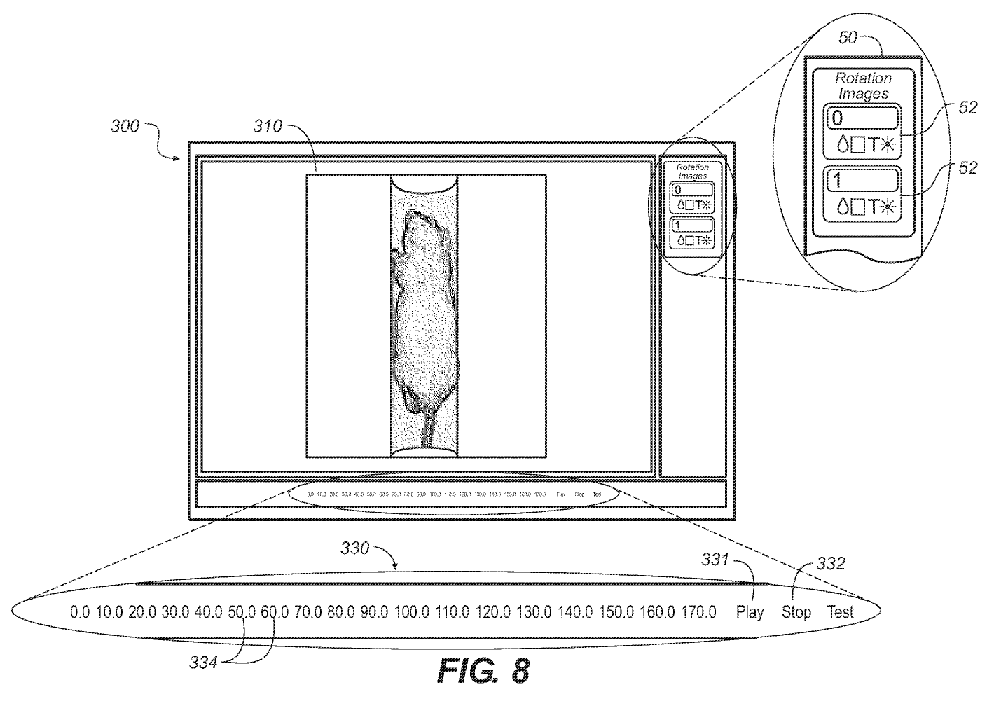

As shown more particularly in FIG. 8, the graphical user interface (GUI) 300 further comprises a scale 330. In this embodiment, scale 330 provides a series of radio buttons 334, each individually actuable and each labeled for a specific angular displacement value. When the synthesized image for a particular angular displacement displays, the corresponding radio button 334 is displayed in its selected mode. In one embodiment, control logic processing, performed at communications/control system 20 (FIGS. 1B, 1C) scans through the group 44 of image sets 40 (FIG. 5) to determine how many radio buttons 334 are to be displayed in scale 330 and to determine which angular displacement values are to be displayed. Thus, for example, group 44 may have only four image sets, obtained at 0, 45, 90, and 135 degrees respectively. In such a case, scale 330 would be populated with only these four entries associated with radio buttons 334. In an alternate embodiment, one or more fixed sets of values are used for scale 330 and image sets must be obtained according to the one or more fixed sets of values. In yet another embodiment, angular displacement data pertaining to a particular experiment or imaging session is obtained directly from imaging system 100, along with information on the number of component images obtained at each angle and available for each image set, as described earlier.

Scale 330 is used to control display window 310 in a number of ways. In a static or still imaging mode, operator selection of a particular radio button 334 displays an individual synthesized image at the corresponding angular displacement. To display a synthesized image at an alternate angle, the operator clicks on or otherwise selects the corresponding radio button 334. An animated playback mode is also available and can also be enabled using a play control 331. When this is selected, the display sequences through each angular displacement value for successive image sets that are displayed. Looping and pause functions can also be provided for this animated playback mode. In one embodiment, radio button 334 indicators highlight individually as the display sequences from one angle to the next. Both forward and reverse sequencing are available. A stop control 332 terminates the automatic sequencing.

It is noted that the function of scale 330 can be implemented in a number of alternate ways, including the use of a linear GUI element, such as a scroll bar, or a circular dial or other element. Additionally, animation playback controls may include a supplemental control for the frame-rate, as well as controls to increase or decrease a delay between frames, for example. An adjustable delay may be automatically calculated based on the angular difference between each successive pair of frames. Automatic calculation of the adjustable delay may be achieved so as to produce an animated display representing a constant rate of rotation, independent of whether the angular difference between different successive pairs of frames is fixed or variable. The controls may further include a range control to limit either the available angular browsing range, the animation playback range, or both, to user-selected start- and end-angles.

A component image selection panel 50 is also shown in FIGS. 7 and 8. With respect to FIGS. 4-7, component image selection panel 50 enables operator selection of the individual types of component images whose content is combined and displayed as a synthesized image (for example, to form synthesized image 320a in FIGS. 5 and 7). In the example of FIG. 7, two component images, 42b and 42c, have been previously selected for combination and are enabled for display. This selection is made using component enable controls 52. Each component enable control 52 selects whether or not image content for the corresponding component image is to be used when combining image data to form a synthesized image for display. Where simple layering of pixels is the combination method, component enable controls 52 can be considered to enable or disable various “layers” in the synthesized image. However, since layering is only one of a number of possible methods usable for combining the image data, as noted earlier, component enable controls 52 more generally enable or disable use of the corresponding image data when forming the composite synthesized image. It should be noted that the example screens shown in FIGS. 7-15 show the use of two component images; in practice, any number of component images can be used, each component image having its corresponding component enable controls 52 and related imaging utilities, as described in more detail subsequently. Moreover, selections made using component enable controls 52 and related imaging characteristics settings apply for each subsequent image that displays until the setting is changed or new image data is provided.

Alternately, image content for either of the component images 42b or 42c could be displayed individually. Control software associated with the GUI determines, either automatically or by means of manual entry, how many component images are available within the image sets that are to be displayed and allocates space on the user interface screen accordingly. Advantageously, component image selection can be performed with display window 310 operating in either static imaging or animated playback mode, without interruption of the animated playback sequence. Thus, for example, display using a particular component image can be enabled or disabled at suitable times during animated rotation of the object.

### Controls for Image Quality and Display Characteristics

Component image selection panel 50 also includes a number of utilities for controlling various image quality and display characteristics of the corresponding image component that is displayed. Settings made on component image selection panel 50 apply for all component images of that type. For a number of imaging characteristics, settings associated with component enable control 52 for one component image are independent of settings associated with component enable control 52 for a different component image. Thus, for a number of the adjustments described herein, imaging adjustments can be performed only on the “layer” that is associated with one image component, independent of the image data of other layers, that is, from other component images.

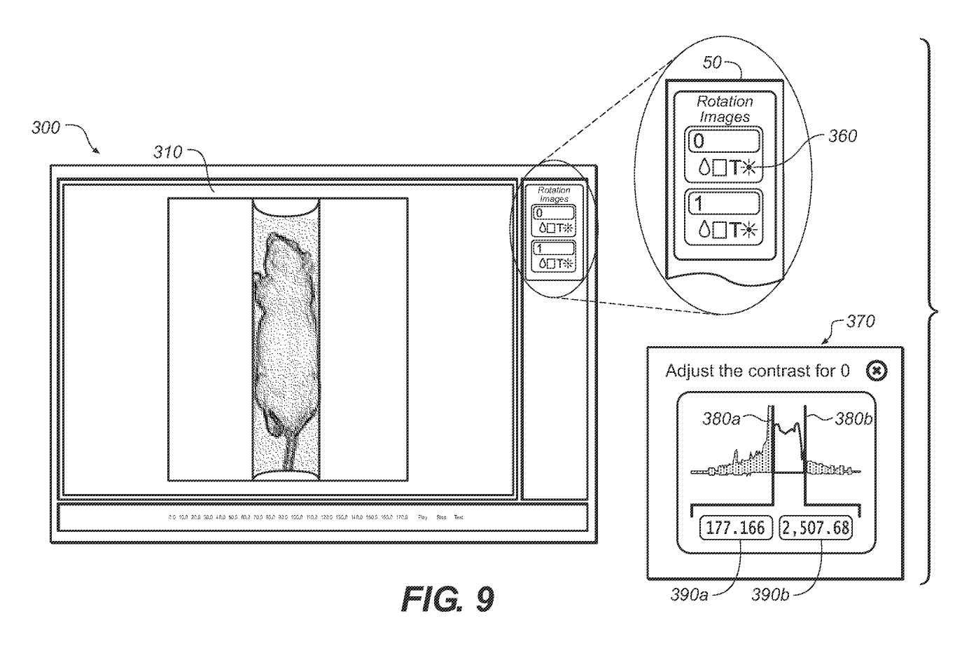

As shown in FIG. 9, operator selection of an image contrast control 360 displays a histogram 370 of the pixel signal values for the corresponding component image. Range controls 380a and 380b are adjustable vertical cursors that enable the operator to expand or contract the range of image data values that are used for image display, thereby manipulating the image contrast. Image contrast control 360 further includes numerical indicators 390a and 390b which indicate the selected numerical pixel signal values corresponding to range controls 380a and 380b, respectively. The graphical user interface 300 converts the contrast settings from a pixel signal value scale to a pseudo-color intensity scale upon graphical rendering of the image. The image contrast selection may globally apply to a corresponding type of component image among the image sets, for example all images of a given modality. This feature enables each component image of synthesized images, for example, to have separate contrast settings, wherein the individual contrast setting is used globally for all images of the specified component. Advantageously, both the contrast selection and the conversion can be applied during animation playback, without interruption of the playback. Alternately, contrast adjustment can be applied while the display is static, in still imaging mode.

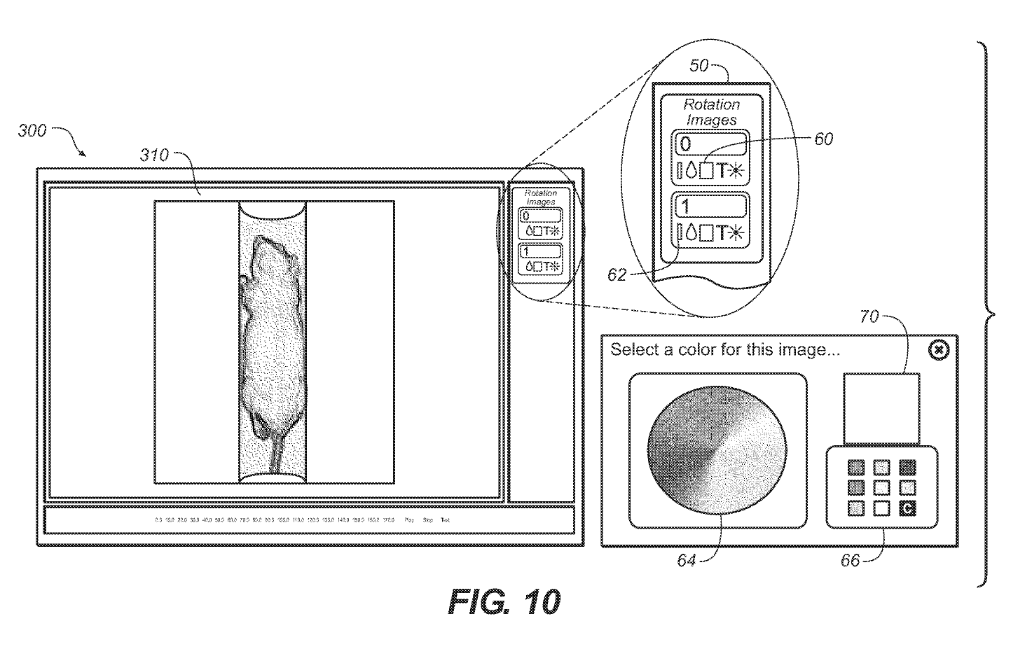

Referring to FIG. 10, component image selection panel 50 also includes a pseudo-color control 60 that applies for the corresponding component image. The image pseudo-color control 60 provides a panel showing a continuous color palette 64, a discrete color palette 66, and an indicator 70 that shows the current selection. The graphical user interface 300 applies the pseudo-color selection upon graphical rendering of the image. The image pseudo-color selection may apply globally to all component images of a given type, for example all images of a given modality. Each component image can be individually pseudo-colored, wherein the individual pseudo-coloring applies globally throughout the sequence of image sets that display. The pseudo-color selection may be applied during animation playback mode without interruption of the playback, or may be applied while the display is in static imaging mode. A color invert toggle 62 enables the operator to invert the color treatment for each component image type, applicable to all images of that type and enabled during both animation playback and static display modes.

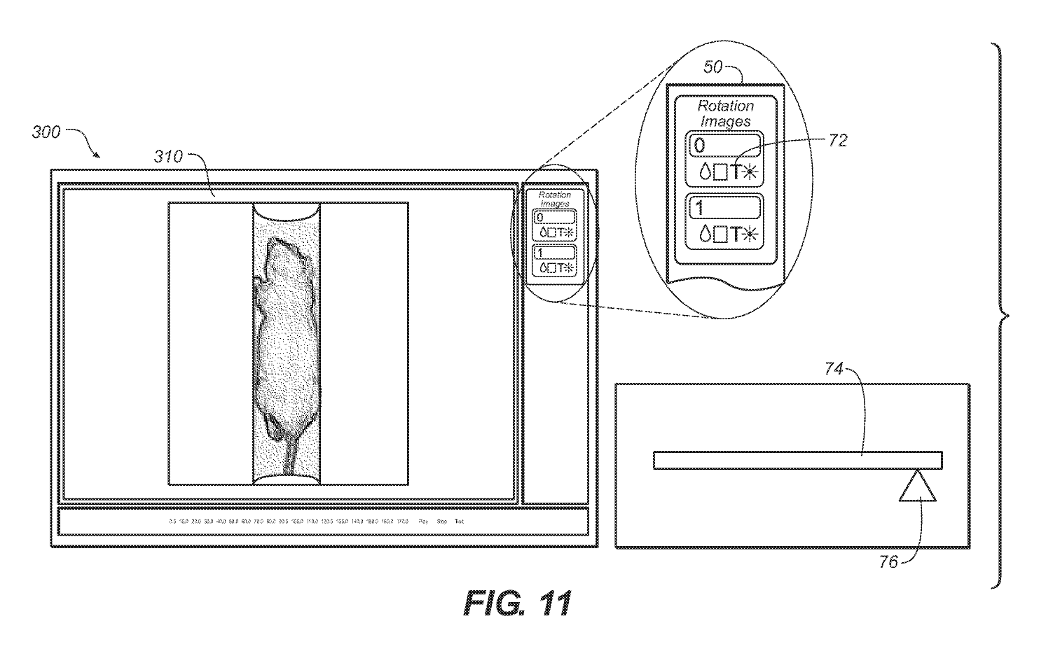

Referring to FIG. 11, component image selection panel 50 also includes an image transparency control 72 that applies for the corresponding component image. In this embodiment, image transparency control 72 has a scale bar 74 and a slideable cursor 76. The graphical user interface 300 applies the transparency selection to the corresponding component image content upon rendering of the synthesized image. The image transparency selection may apply globally to all component images of a given type, for example all images of a given modality. An individual adjustment can apply globally to all component images of one type throughout the series of image sets that display. The transparency selection may be applied during animation playback mode without interruption of the playback, or may be applied in static display mode.

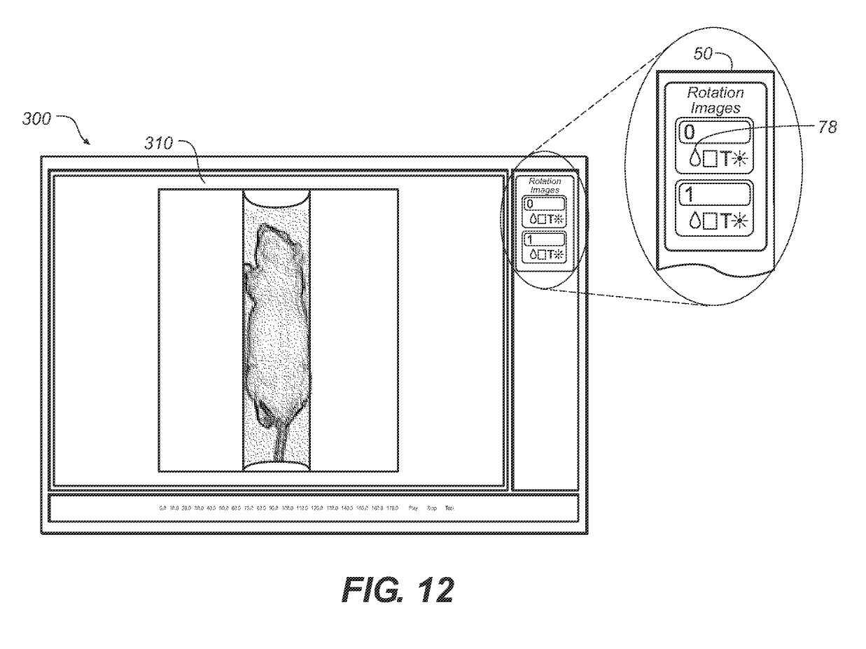

Referring to FIG. 12, component image selection panel 50 also includes an image smoothing control 78 that applies for the corresponding component image. Image smoothing control 78 executes a smoothing algorithm that is applied upon graphical rendering of the image. The smoothing setting may apply globally to all component images of a given type, for example all images of a given modality. Each component image can be individually smoothed, wherein the individual pseudo-coloring applies globally throughout the sequence of image sets that display. The smoothing selection may be applied during animation playback mode without interruption of the playback, or may be applied while the display is in static imaging mode.

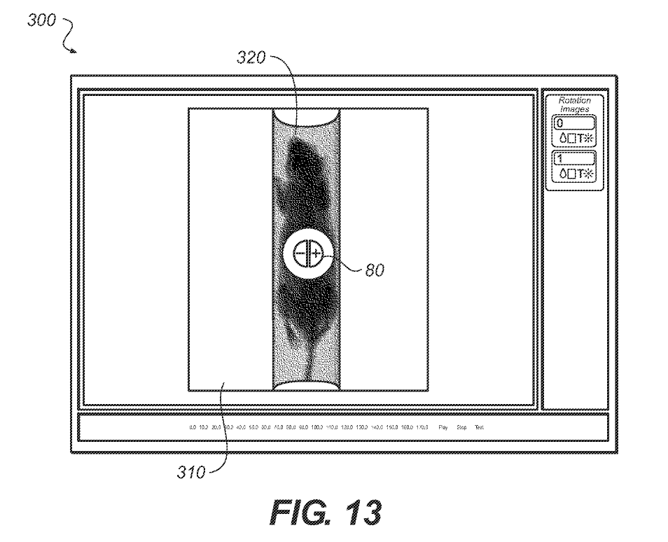

As shown in FIG. 13, graphical user interface 300 also provides a zoom control 80 that allows the operator to zoom in or out for the synthesized image 320 in display window 310. In the embodiment shown, the operator selects the “+” symbol to zoom or magnify and the “−” symbol to zoom out or demagnify. Magnification and demagnification controls can be selected in a variable manner, for example by a variable number of multiple selections or “clicks” or by a variable time interval of the selection, so as to achieve the desired image magnification. Zoom control may be applied during animation playback mode without interruption of the playback, or may be applied in static display mode.

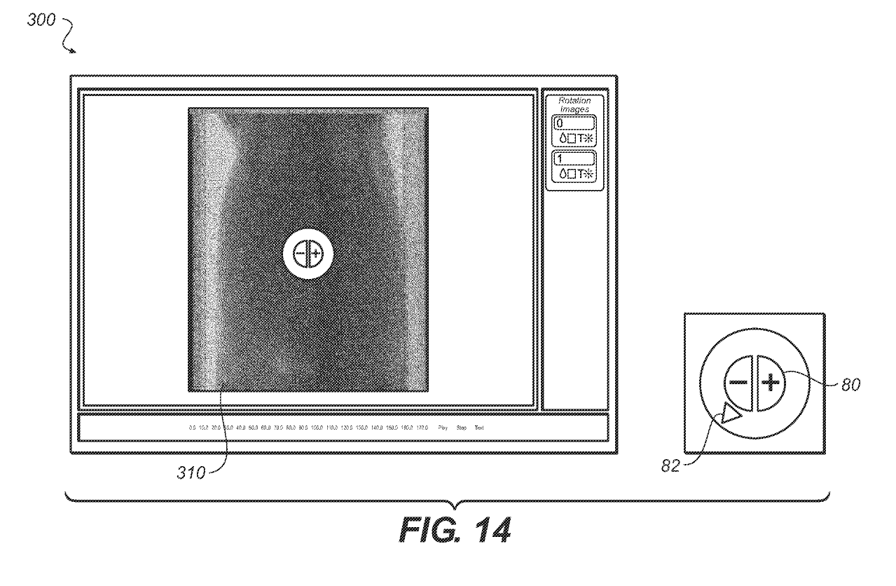

FIG. 14 shows how an image panning function is implemented in one embodiment. Once image 320 is enlarged, zoom control 80 provides an additional pan control 82, indicated by an arrow symbol. Upon selection of the pan control 82, the graphical user interface 300 pans image 320 within display window 310. The pan distance is variable and controlled by the time interval during which the pan control is selected, for example. The pan velocity is also variable and controlled by the radial distance of selection of pan control 82. The pan acceleration is also variable and controlled by varying the radial distance of the selection of pan control 82. Pan control may be applied during animation playback mode without interruption of the playback, or may be applied in static display mode.

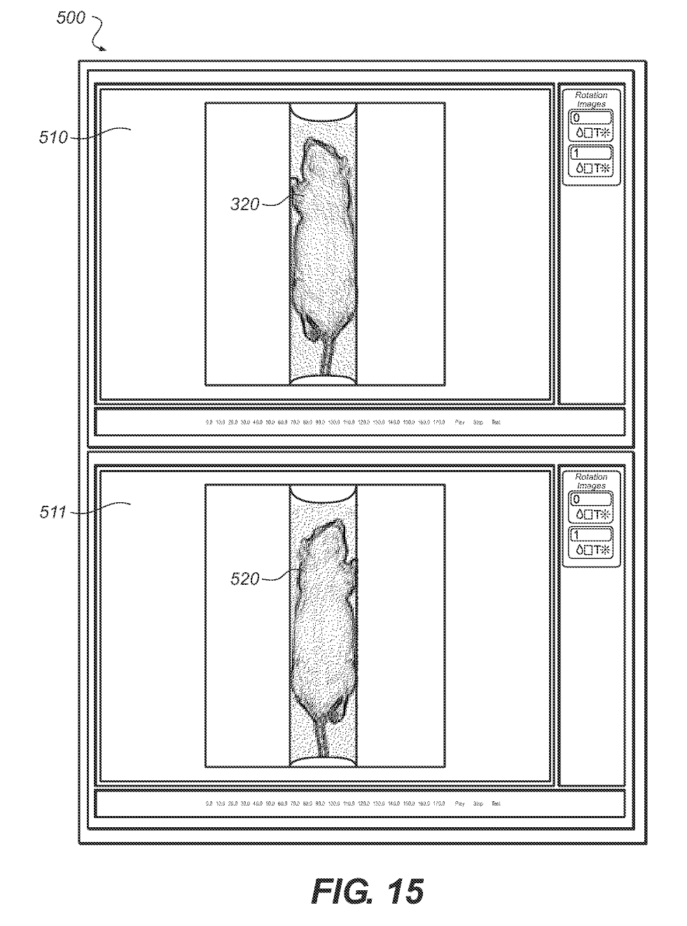

FIG. 15 shows a graphical user interface 500 in accordance with another embodiment of the present invention wherein each of a plurality of display windows, here comprising two display windows 510 and 511, displays different synthesized images 320 and 520, each synthesized image corresponding to a different image set of multi-modal images. Using this dual-view capability, for example, an angle-lag may be applied during animation playback without interruption of the playback, or may be applied while the display is static. Additional angle indicators (not shown) may provide an indication of the angle of images that display in each interface window.

A graphical user interface such as graphical user interface 500 in FIG. 15, having a plurality of display windows, is useful for better visualizing the three-dimensional character of multi-modal signals, such as the anatomical context of a molecular signal. Each display window 510 and 511 in the plurality has individually associated component image selection, image contrast, image pseudo-color, image transparency, image smoothing, zoom, and pan controls. Each display window in the plurality may be individually configured according to its associated controls. The individual configuration may be applied during animation playback without interruption of playback in an animation playback mode, or may be applied while the display is in static display mode. Alternatively, one display window among the plurality may be selected as a master display window, and the other display windows in the plurality would act as slave display windows, whereby the controls associated with the master display window globally apply to the slave display windows. The global configuration may be applied during animation playback without interruption of the playback, or may be applied while the display is static.

It is noted that a number of support utilities may be provided for graphical user interface 300. For example, in one embodiment an administrative tool is used to specify the angular increments used in a particular experiment and corresponding to the different image sets that have been obtained. As part of this utility, tools are provided so that component images for the experiment are properly identified. An administrative utility is also used to specify the algorithms and techniques to be used to combine the different component images corresponding to each angular increment. In another embodiment, software associated with GUI 300 automatically scans and categorizes a group 44 of image sets 40 that it receives (FIG. 5) and, as a result of its automated processing, populates scale 330 and component image selection panel 50 (FIGS. 7, 8) for the proper angles and number of component images to be used.

A number of additional utilities can be provided. For example, the graphical user interface may include tools for segmenting the images into regions of interest, for example, as defined based on the application of a watershed algorithm, or similarly based on a threshold set as a percentage of the image maximum, as known in the art. The graphical user interface may further include indicators of calculated statistics of the regions of interest, such as the sum of the pixel signal values within each region of interest. The graphical user interface may further include graphical indicators or tabular displays of the calculated statistics of the regions of interest versus rotation angle, wherein these displays may be synchronized to the animation of the display as a function of modality and rotation angle. The graphical user interface may further include controls for exporting the contrasted and zoomed images and animation playback, as well as for export of calculated statistics, into file types suitable for viewing in common third-party applications, such as web browsers, and presentation and publishing software. Further command capabilities available to the operator include the capability to export an animated display sequence in a standard animation file format, such as Audio Video Interleave (AVI), for example.

The graphical user interface may also be extended to add additional dimensions to the display of the multi-modal image data in addition to the single dimension (angular displacement) described above. These additional dimensions may include time (i.e., multiple sets of data collected at different times, each with a set of angular displacements), or further spectrum (i.e., multiple sets of data collected at different times, each with a set of measurements at different wavelengths, energy, or frequency). When additional dimensions are present, the graphical user interface may include additional controls that allow the user to browse, activate, or animate the extra dimensions, in a manner similar to the controls used for browsing, activating, or animating the angular displacement dimension, as described earlier.

Features of graphical user interface 300 provide considerable advantages for viewing various types of overlaid and composite synthesized images, particularly in areas of molecular imaging. For example, the capability to modify how image content is presented for one or more component images, and to do this dynamically as the synthesized image is rotating in display window 310, allows a researcher to more thoroughly examine the subject in order to assess various conditions, such as the progress of an infection or lesion, or the effects of various injected substances.

The invention has been described in detail with particular reference to a presently preferred embodiment, but it will be understood that variations and modifications can be effected within the spirit and scope of the invention. For example, image presentation utilities such as color palettes, transparency adjustments, and pan and zoom tools could have alternate interface mechanisms other than those shown and described herein. The group and image set data arrangement described with reference to FIGS. 4 and 5 uses some form of logical linking between images of the same subject, taken in different imaging modalities and at different reference angles, and can be implemented in any number of ways and is not limited to any particular type of data structure or encoding or database arrangement.

The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

12 light source
14 optical compartment
16 mirror
18 lens/camera system
20 communication/computer control system
30 radiation source
32 object
34 sensor
40, 40a, 40b, 40c . . . 40z image set
42, 42a, 42b, 42c . . . 40z component image
44 group
50 component image selection panel
52 component enable control
60 image pseudo-color control
62 color invert toggle
64 continuous color palette
66 discrete color palette
70 indicator
72 image transparency controls
74 scale bar
76 slideable cursor
78 image smoothing control
80 image zoom control
82 image pan control
100 electronic imaging system
102 microfocus X-ray source
104 platen
106 fiber optics
108 sample environment
110 access means/member
150 animal (mouse)
151 arrow
160 optically transparent planar animal support member
200 high-resolution phosphor screen
201 arrow
205 high-resolution phosphor sheet
300 graphical user interface
310 display window
320a synthesized image
320 synthesized image
330 scale
331 “play” control
332 “stop” control
334 radio button
360 image contrast controls
370 histogram
   380a, 380b range controls
390a,b indicators
400, 410A, 410B, 410C, 410D method step
412, 414, 416, 418 method step
420 method step
440, 460 method step
470 method step
472A, 472B, 472C, 472D method step
474, 476, 478 method step
500 graphical user interface
510, 511 display windows
520 synthesized image
S80 synthesized image obtaining step
S82 image set forming step
S84 image set selection step
S86 synthesized image forming and display step
A Axis

1. A method for forming a sequence of images of a subject, comprising:
a) obtaining at least first and second image sets of the subject, wherein each image set has a given angular displacement relative to an axis of rotation of the subject, each image set comprising at least:
(i) a first component image of a first diagnostic modality at the given angular displacement; and
(ii) a second component image that is co-registered to the first component image at the given angular displacement;
b) selecting the first image set as the selected image set for display;
c) forming a synthesized image by combining image data from the at least first and second component images of the selected image set; and
d) displaying the synthesized image.

2. The method of claim 1 further comprising:
selecting the second image set as the selected image set for display; and
repeating steps c) and d).

3. The method of claim 1 wherein the given angular displacement corresponds to a cranio-caudal rotation angle.

4. The method of claim 1 wherein the second component image is of the first diagnostic modality and wherein the first and second component images have different spectral bands.

5. The method of claim 1 wherein the second component image is of a second diagnostic modality.

6. The method of claim 1 wherein obtaining the at least first and second image sets comprises obtaining images of different dimensions.

7. The method of claim 1 wherein obtaining the at least first and second image sets comprises obtaining images from the same imaging apparatus.

8. The method of claim 1 wherein obtaining the at least first and second image sets comprises obtaining images from different imaging apparatus.

9. The method of claim 1 further comprising adjusting, for the first component image separately from the second component image, one or more of image contrast, image color, image transparency, and image smoothing.

10. The method of claim 1 wherein the first component image is taken from the group consisting of an x-ray image, a fluorescence image, a bright field image, a luminescence image, and a radioisotopic image.

11. The method of claim 1 wherein selecting the first image set as the selected image set comprises accepting an operator command from a graphical user interface.

12. The method of claim 2 further comprising executing an animated display sequence that periodically repeats steps b), c), d), e), and f).

13. A graphical user interface for multi-modal image display of a subject comprising:
a plurality of angular displacement selection controls, wherein each angular displacement selection control is actuable to select a corresponding rotation angle as a selected rotation angle and is associated with at least a first image of a first diagnostic modality at said selected rotation angle and a second image that is co-registered to the first component image at said selected rotation angle;
a first image enable control that is actuable to enable or disable display of image content of the first image;
a second image enable control that is actuable to enable or disable display of image content of the second image; and
a display area capable of displaying a synthesized image formed from image content of the at least first and second images.

14. The graphical user interface of claim 13 further comprising:
a first color control that is actuable to modify the color content of the first image independently from the color content of the second image; and
a second color control that is actuable to modify the color content of the second image independently from the color content of the first image.

15. The graphical user interface of claim 13 further comprising a pan control for adjusting the position of the synthesized image within the display area.

16. The graphical user interface of claim 13 further comprising controls for adjusting one or more of contrast, transparency, and smoothing for image content of the first image, independent of adjustment for image content of the second image.

17. A graphical user interface for display of a synthesized image of a subject, the interface comprising:
a display area that is disposed to display the synthesized image formed as a combination of image content from a first image of a first diagnostic modality and a second image of a second diagnostic modality, wherein the synthesized image has an associated rotation angle;
a plurality of angular displacement controls, wherein each angular displacement control is actuable to select the rotation angle;
a first image enable control that is actuable to enable the use of image data of the first image for forming the synthesized image; and
a second image enable control that is actuable to enable the use of image data of the second image for forming the synthesized image.

18. The graphical user interface of claim 17 wherein each angular displacement control further has an associated indicator that indicates selection of the corresponding rotation angle.

19. The graphical user interface of claim 17 further comprising an animation toggle that automatically sequences through each of the plurality of angular displacement controls in order.

20. The graphical user interface of claim 17 further comprising a third image enable control that is actuable to enable the use of image data of a third image of a third diagnostic modality for forming the synthesized image at the selected rotation angle.

21. A method for forming a sequence of images of a subject, the method comprising:
obtaining at least first and second image sets of the subject, wherein each image set has a given angular displacement relative to an axis of rotation of the subject, each image set comprising at least:
(i) a first component image of a first diagnostic modality at the given angular displacement; and
(ii) a second component image of a second diagnostic modality that is co-registered to the first component image at the given angular displacement;
selecting the first image set as the selected image set for display;
forming a synthesized image by combining image data from the at least first and second component images of the selected image set; and
displaying the synthesized image.

22. A method for forming a sequence of images of a subject, the method comprising:
obtaining at least first and second image sets of the subject, wherein each image set has a given angular displacement relative to an axis of rotation of the subject, each image set comprising at least:
(i) a first component image of a first diagnostic modality at the given angular displacement; and
(ii) a second component image of the first diagnostic modality that is co-registered to the first component image at the given angular displacement;
selecting the first image set as the selected image set for display;
forming a synthesized image by combining image data from the at least first and second component images of the selected image set; and
displaying the synthesized image.
